(19) United States
(12) Patent Application Publication
(10) Pub. No.: US 2015/0379497 A1
(43) Pub. Date: Dec. 31, 2015

(54) System, device, and method for self-checkout shopping

(71) Applicant: Miguel Florez, Highlands Ranch, CO (US)

(72) Inventor: Miguel Florez, Highlands Ranch, CO (US)

(21) Appl. No.: 14/747,305

(22) Filed: Jun. 23, 2015

Related U.S. Application Data
(60) Provisional application No. 62/018,383, filed on Jun. 27, 2014.

(51) Int. Cl. G06Q 20/20; G06Q 40/00; G06Q 20/10

(52) U.S. Cl. CPC G06Q 20/204; G06Q 20/10; G06Q 40/12; G06Q 20/208

(57) ABSTRACT

A system for self-checkout shopping includes a self-checkout server and a self-checkout device, such that the self-checkout server communicates with a payment system, or a payroll system, to manage payment for shopping transactions, and the self-checkout device scan items for purchase, manages a shopping cart, and completes a purchase transaction. A customer can use the self-checkout device, executing on a mobile device, to purchase individual items, by barcode scanning or manual entry for each item, and completing a purchase transaction in the self-service application, which communicates with the self-checkout server for processing payment transactions and storing the sales transactions. Also disclosed is a method for self-checkout including starting shopping transaction, scanning item, updating shopping cart, moving item to physical cart, repeating purchase for new item, validating shopping transaction, and completing shopping transaction.

### CROSS-REFERENCE TO RELATED APPLICATIONS

This application claims the benefit of U.S. Provisional Application No. 62/018,383, filed Jun. 27, 2014.

### FIELD OF THE INVENTION

The present invention relates generally to the field of systems, devices, and methods for managing sales operation of shops and food markets, and more particularly to methods and systems for providing mobile device self-checkout capabilities without use of a dedicated checkout kiosk or checkout attendant.

### BACKGROUND OF THE INVENTION

Self-service shops have become a growing business segment that offers a simple self-service experience to customers, while lowering operating costs for shop operators. Grocery stores and supermarkets have therefore increasingly adopted use of self-check stations, typically as a supplement to traditional attendant operated checkout stations.

Such self-service shops are particularly suited for operation inside environments where customer security and access is well controlled. Particularly, companies or organizations can provide space for self-service shops, and thereby allow a third-party shop operator to sell store goods to employees of the company.

Typically, these self-service shops may use dedicated checkout kiosks for recording a sales transaction of items selected by a customer. These checkout kiosks can occupy significant store space and are generally relatively expensive. These costs may significantly limit the financial viability of self-service shops.

As such, considering the foregoing, it may be appreciated that there continues to be a need for novel and improved devices and methods for operating self-service shops.

### SUMMARY OF THE INVENTION

The foregoing needs are met, to a great extent, by the present invention, wherein in aspects of this invention, enhancements are provided to the existing models for operation of self-service shops, which can significantly lower the cost of establishing a retail self-service option for customers in the store.

In an aspect, a system for self-checkout can include a self-checkout server connected with a self-service application, which executes on a mobile device that is carried by a customer.

In related aspects, the customer can use the self-checkout device to purchase individual items, by scanning a barcode or other type of code for each item, or entering the weight of an non-barcode item, and completing a purchase transaction in the self-service application, which communicating with the self-checkout server for processing payment transactions and storing the sales transactions.

In related aspects, the self-checkout server can integrate with external payment systems, with an employ payroll system, or with a proprietary payment system, in order to manage purchase transactions.

In a related aspect, the self-checkout device can use an inbuilt camera to scan item codes, such as UPC or QR codes, and can simultaneously capture a video recording to document the individual selection of an item.

In a related aspect, a complete sales transaction can be linked to video captures of the store environment, which are recorded by the self-checkout server.

In related aspects, a self-checkout system can be configured to operate for one store, or a chain of stores, or it can be configured to provide service for several store operators, each operating a set of stores.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a system for self-checkout shopping, according to an embodiment of the invention.

FIG. 2 is a schematic diagram illustrating a self-checkout server, according to an embodiment of the invention.

FIG. 3 is a schematic diagram illustrating a self-checkout device, according to an embodiment of the invention.

FIG. 4 is an illustration of a first application window of the graphical user interface of the self-checkout device, according to an embodiment of the invention.

FIG. 5 is an illustration of a second application window of the graphical user interface of the self-checkout device, according to an embodiment of the invention.

FIG. 6 is an illustration of a third application window of the graphical user interface of the self-checkout device, according to an embodiment of the invention.

FIG. 7 is an illustration of a fourth application window of the graphical user interface of the self-checkout device, according to an embodiment of the invention.

FIG. 8 is a flowchart illustrating steps that may be followed, in accordance with one embodiment of a method or process of self-checkout shopping.

FIG. 9 is a flowchart illustrating steps that may be followed, in accordance with one embodiment of an algorithm for shopping promotion.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

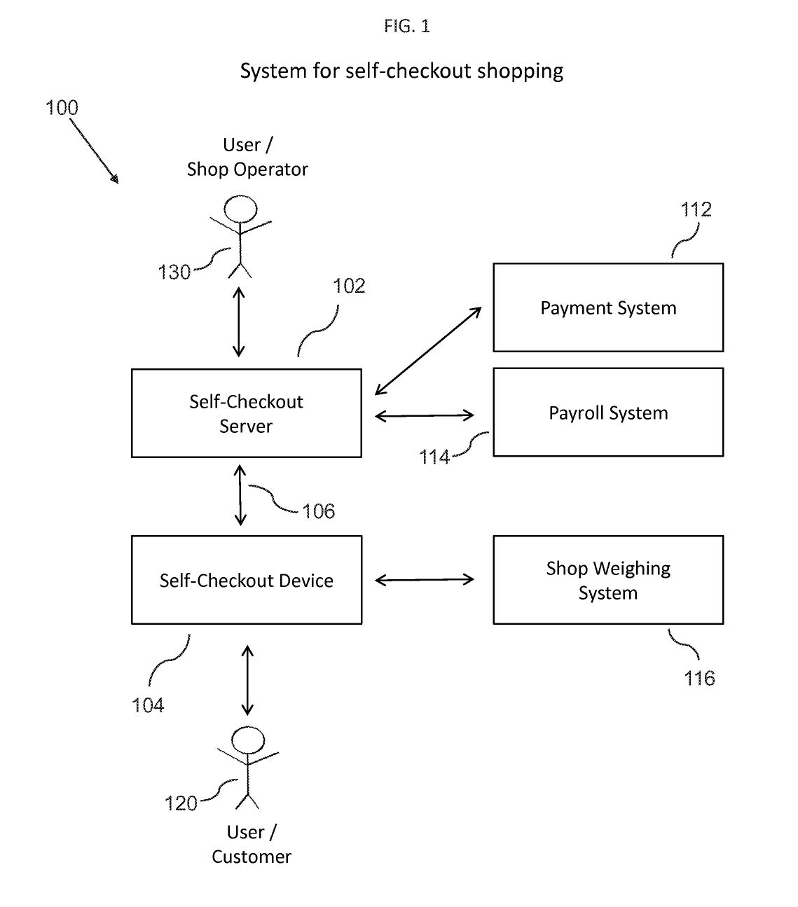

In the following, we describe the structure of an embodiment of a system for self-checkout shopping 100 with reference to FIG. 1, in such manner that like reference numerals refer to like components throughout; a convention that we shall employ for the remainder of this specification.

In an embodiment a system for self-checkout shopping 100 can comprise:
a) a self-checkout server 102; and
b) a self-checkout device 104;
wherein the self-checkout device 104 is configured to register items for purchase, by scanning or manual entry of the items, and process sales transactions in a store, such that the sales transactions are stored in the self-checkout server 102;
wherein the self-checkout server 102; can communicate with one or more payment systems 112, and one or more payroll systems 114, to manage payment for shopping transactions, and the self-checkout device 104 can scan items for purchase, and manage a shopping cart, and complete a purchase transaction.

In a related embodiment, a self-checkout server 102 can be comprised of:
a. A processor 202;
b. A non-transitory memory 204;
c. An input/output component 206;
d. At least one shop camera 208
e. A transaction manager 210;
f. A transaction database 212;
g. A customer database 214;
h. A product database 216;
i. An operator manager 218;
j. A payment manager 220; and
k. A shopping analyzer 222; all connected via
l. A data bus 230.

In a related embodiment, the transaction manager 210 can store and process sales transactions in communication with the self-checkout device 104.

In a related embodiment, the transaction database 212 can store transaction records which can include fields
a. market id;
b. system card number;
c. Item number;
d. Date
e. Amount;
f. Employee balance; for storing a cumulative payroll amount.

In a related embodiment, the customer database 214 can store customer and store records which can include fields
a. market id;
b. customer number;
c. system card number;
d. user/employee balance;
e. user/employee email;
f. system card details;
g. accumulated reward points;
h. balance add-on amount.

In a related embodiment, the payment manager 220 can be configured to manage payments by:
a. Integration with an external payment system 112, which for example can include integration with an external digital wallet;
b. Integration with a payroll system 114, for example for users 120 which are employees in a company that is a host for a shopping store, such that a purchase amount is deducted from the users employee payroll account; or
c. Integration with a proprietary payment system, provided via functions of the payment manager 220.

In a further related embodiment, the proprietary payment system provided by the payment manager 220 can be configured to offer payment transaction processing that is suitable for micro payments. A related payment model can for example have no fixed transaction fee, but only a percentage based transaction fee. Traditional payment systems or digital wallets may have a fixed transaction fee, such as $0.20-$0.30 per transaction, in additional to a percentage based transaction fee, which can be uneconomical for small store transactions.

In a related embodiment, a self-checkout device 104 can comprise:
a. A processor 302;
b. A non-transitory memory 304;
c. An input/output 306;
d. A device camera 308;
e. A shopping controller 310;
f. A code scanner 312; and
g. A location service 314; all connected via
h. A data bus 320;
wherein the shopping controller 310 is configured to register and store items for purchase, and wherein the shopping controller 310 communicates with the transaction manager 210 of the self-checkout server 102, to store and process sales transactions.

In related embodiments, the self-checkout device 104 can include configurations as:
a. A web application, executing in a Web browser;
b. A tablet app, executing on a tablet device, such as for example an Android or iOS tablet device;
c. A mobile app, executing on a mobile device, such as for example an Android phone or iPhone, or any wearable mobile device;
d. A desktop application, executing on a personal computer, or similar device;
e. An embedded application, executing on a processing device, such as for example a smart TV, a game console, a customer kiosk or other system.

It shall be understood that an executing instance of an embodiment of the system for self-checkout 100, as shown in FIG. 1, can include a plurality of self-checkout devices 104, which are each tied to one or more users 120.

An executing instance of an embodiment of the system for self-checkout 100, as shown in FIG. 1, can similarly include a plurality of self-checkout servers 102.

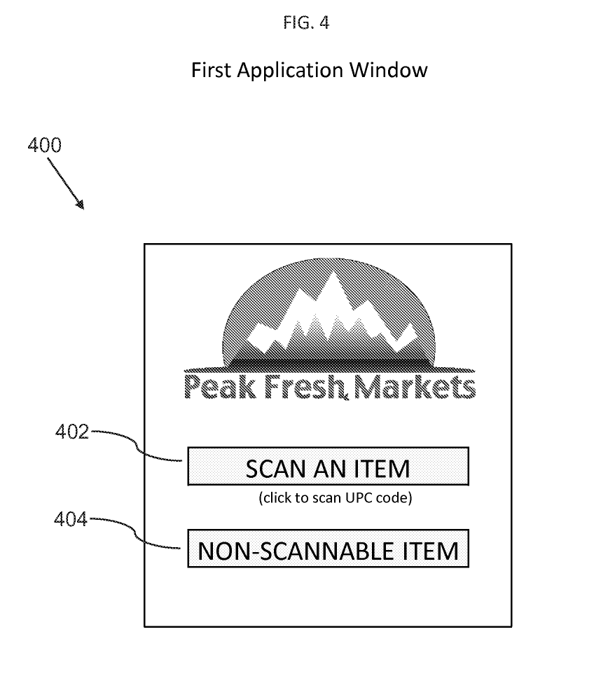

In a related example embodiment, FIG. 4 shows a first self-checkout device window 400 associated with the graphical user interface for the self-checkout device 104, provided by the shopping controller 310, including:
a) an item scan button 402, for scanning an item for purchase, such that the item scan button starts the scan for a first item, as part of a new sales check-out transaction; and
b) a manual entry button 404, for registering a non-scannable item for purchase, by manually entering a product code, and optionally entering a weight, as part of an on-going sales check-out transaction;

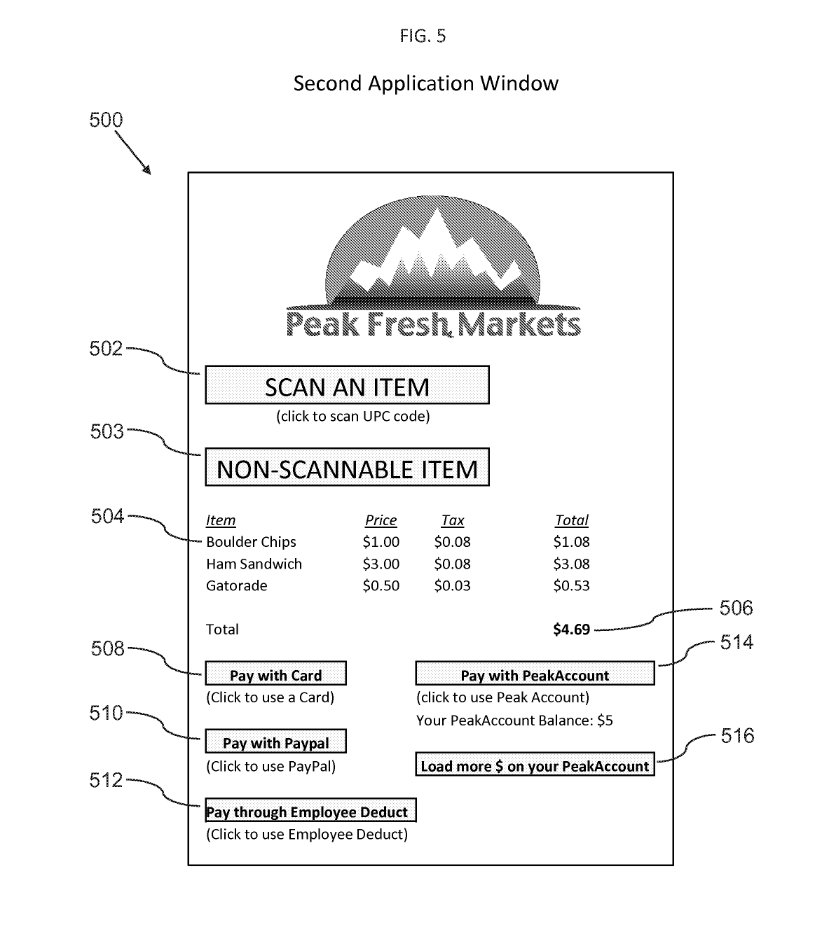

In a related example embodiment, FIG. 5 shows a second self-checkout device window 500 associated with the graphical user interface for the self-checkout device 104, provided by the shopping controller 310, including:
c) an item scan button 502, for scanning an item for purchase, such that the item scan button starts the scan for a next item, as part of an on-going sales check-out transaction;
d) a manual entry button 503, for registering a non-scannable item for purchase, by manually entering a product code, and optionally entering a weight, as part of an on-going sales check-out transaction;
e) A list of registered items 504;
f) A total price display 506, showing the accumulated sales price for the list of registered items 504;
g) A credit card payment button 508, for ending the sales check-out transaction and paying with a credit card;
h) A PayPal payment button 510, for ending the sales check-out transaction and paying with PayPal;
i) A Pay through employer button 512, for ending the sales check-out transaction and paying with an employee account, such that the shopping controller 310 communicates with the payment manager 220, which communicated with an external payroll system 114, to deduct the purchase price from a payroll account of the user 120;
j) A Pay through system account button 514, for ending the sales check-out transaction and paying with a pre-paid system account, such that the shopping controller 310 communicates with the payment manager 220, which deducts the sales amount from a payment account of the user 120;
k) A system account transfer button 516, for transferring money to a system account of the user 120, such that the shopping controller 310 communicates with the payment manager 220, which is configured to manage transfer of funds to the system account.

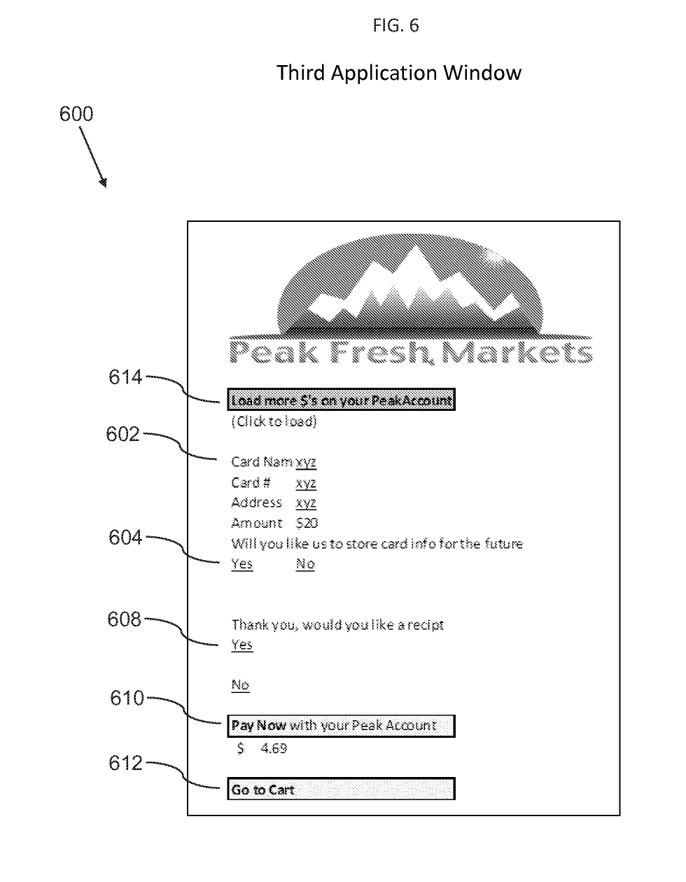

In a related example embodiment, FIG. 6 shows a third self-checkout device window 600 associated with the graphical user interface for the self-checkout device 104, provided by the shopping controller 310, including:
a. A system account transfer button 614, for transferring money to a system account of the user 120, such that the shopping controller 310 communicates with the payment manager 220, which is configured to manage transfer of funds to the system account.
b. Card information entry fields 602, for entering credit or payment card information;
c. Credit card storage user input buttons 604, for entering information on whether to store the credit or payment card information for use in future sales transactions;
d. Receipt buttons 608, for entering information on whether the shopping controller 310 should print a receipt via the input/output 306;
e. A Pay through system account button 610, for ending the sales check-out transaction and paying with a system account, such that the shopping controller 310 communicates with the payment manager 220, which deducts the sales amount from a payment account of the user 120;
f. A go to cart button 612, for returning to the second application window 500.

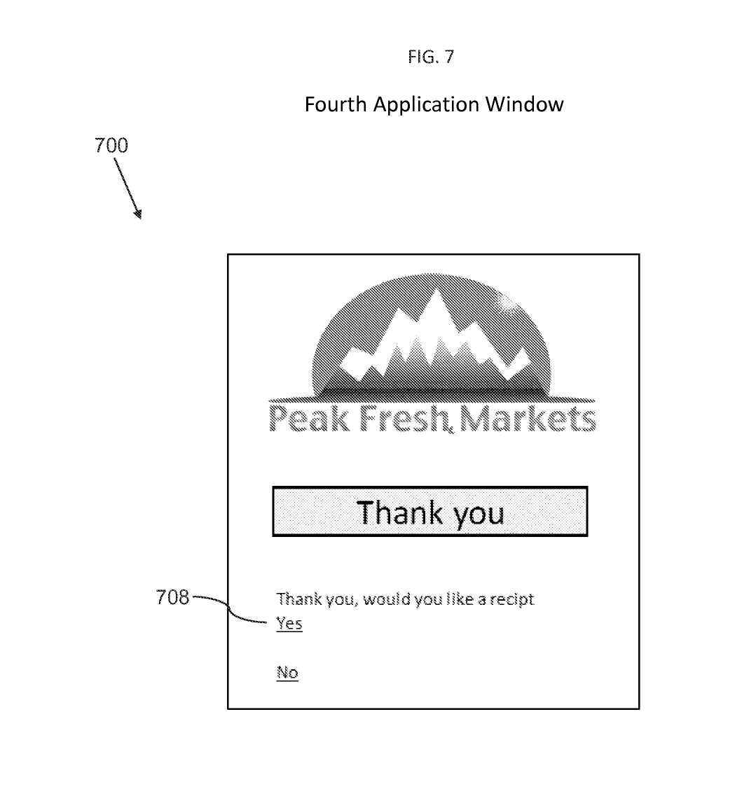

In a related example embodiment, FIG. 7 shows a fourth self-checkout device window 700 associated with the graphical user interface for the self-checkout device 104, provided by the shopping controller 310, for finalizing a sales transaction, including:
a. Receipt buttons 708, for entering information on whether the shopping controller 310 should print a receipt via the input/output 306, as part of finalizing the sales transaction.

In a related embodiment, the code scanner 312 can be configured to:
a. Capture a picture of an item code, such as a UPC barcode or a QR code, with the device camera 308 and decode the image to obtain an item number; or
b. Scan a UPC barcode via a barcode scanner device that is attached via the input/output 306, to obtain an item number.

In a related embodiment, the shopping controller 310 can be configured to complete an item purchase by capturing a video, via the device camera 308, from the event of scanning and retrieving a shop item, such that during recording of the event, the code scanner 312 can capture the item code, such as a UPC bar code, of the shop item. The video and the code can then be communicated by the shopping controller 310 to the self-checkout server 102 for storage in the transaction database 212.

In a related embodiment, the location service 314 can be configured to determine a location of the self-checkout device 104, which for example can be provided by a GPS system in the and/or with cell phone tower tri-angulation.

In a related embodiment, the product database 216 of the self-checkout server 102 can include a price table, with columns including:
a. Item number, which can be a SKU number;
b. Item name;
c. Market;
d. Sub-market;
e. Price;
f. Cost;
g. Quantity in hand;
h. UPC code;
i. Weight price; and
j. Reward points, which defines how many points are accumulated for a purchase.

In a related embodiment, the shopping controller 310 can be configured to retrieve, store, and update reward points that are earned by a customer 120 during shopping. At checkout, a customer 120 can apply the reward point balance against a total amount from current shopping transaction.

In a related embodiment, the system for self-checkout shopping 100 can further include:
a. a shop weighing system 116, which is connected to the self-checkout device 104 via a network;
such that the shopping controller 310 can be configured to validate a weight of items in a shopping transaction; and
such that the shopping controller 310 can be configured to identify shopping items without a bar code and associate them with a weight obtained in communication with the shop weighing system 116.

In a related embodiment, the shop weighing system 116 can be the weight and weighing function of a self-service check-out station as used for self-service in supermarkets and groceries, such that the user 120 is able to weigh items on the weight of the check-out system, but does not need to use the scanner function of the check-out station, as scanning is done by use of the self-checkout device 104.

In a related embodiment, the product database 216 of the self-checkout server 102 can include a discount programs table, with columns including:
a. Market id;
b. Sub-market;
c. Discount program number
d. Product, which defines all the products associated with a discount program number;
e. Combo, a Boolean field which defines if there is one (false) or many (true) products in the discount program;
f. Days, for example “Mon.-Fri.”;
g. Time active, for example 9 AM-11 AM;
h. Start date;
i. End date;
j. Customer segment;
k. Email, (Y/N) which defines if customer should be notified by email in addition to promotion on self-checkout device 104; and
l. Bar code applicable (Y/N).

In a related embodiment, the customer segment field can contain the following type variants:
a. High revenue, equating to the top 30% revenue customers 120;
b. High revenue, equating to the middle 40% revenue customers 120; and
c. High revenue, equating to the bottom 30% revenue customers 120.

In a related embodiment, as shown in FIG. 1, an operator 130 can log on to the self-checkout server 102, typically via a web based interface or via a mobile app, in order to:
a. logon in ‘register’ for the first time and set up an account, then sign in as normal;
b. fill out an Operator profile;
c. Define the shops/markets and products associated with each shop/market;
d. Send link to invite users/customers 120 to download the app in order to make purchases.

In a related embodiment, the system for self-checkout shopping 100 can distribute funds to an operator 130 in an automated fashion, by the operator interacting via the operator manager 218 of the self-checkout server 102, which can include:
a. Fund distribution on a predetermined schedule, which for example can be every week, on the same day, and can further include sending of an auto email to operator 130 stating how much money will be deposited into operator 130 account from Credit Card and/or PayPal™ sales and system account recharge for the week. The email can contain a link for operator 130 to enter bank details for the transfer to take place.
b. Total weekly card purchases and system card recharges will be directed from card processors to operator account and from PayPal™ account into operator account.

In a further related embodiment, an operator 130 can via interaction with the operator manager 218 of the self-checkout server 102, set-up a market with sub-markets, which for example can cover a number of shops in a company building, owned by a company operator 130. Each market will be named and each sub-market will be independently named.

In a yet further related embodiment, the shopping controller 310 can be configured to allow an employee customer 120 to select the sub-market they are shopping in. The selection can be validated by a location confirmation in communication with the location service 314 on the self-checkout device 104. If validation fails, the user can be asked to confirm. Alternatively, the system can automatically determine the market or sub-market based on matching with a location provided by the location service 314.

In another further related embodiment, an operator 130 can via interaction with the operator manager 218 of the self-checkout server 102, store and update product inventories for a pre-determined market or sub-market, which for a pre-determined product number can include updating:
a. Quantity on Hand;
b. Stale Quantity, i.e. how many need to be removed because of expiration;
c. Short Quantity, i.e. how many are missing, due to theft and other reasons;
d. Quantity Change; i.e. how many are added or removed;
Such that
   Updated Quantity on Hand=
      Original Quantity on Hand−Stale−Short+Quantity Change.

In an embodiment, the shopping controller 310 can be configured to execute a shopping promotion algorithm 900 for the purpose of maximizing revenue per sales transaction and/or maximize the number of sales transaction for each customer 120.

In a related embodiment, the shopping promotion algorithm 900 can identify which customer 120 to contact, when to initiate contact, and what offer or promotion to submit to the customer 120, based on a purchase history of the customer 120.

In a related embodiment, base variables are derived for each customer on an ongoing basis during operation of the system for self-checkout shopping 100, to provide statistical modeling input for the shopping promotion algorithm 900, wherein the base variable can include:
a. Products purchased;
b. Product category;
c. Price per item;
d. Total price per transaction;
e. Time of purchase;
f. Product category of the purchases;
g. Day of purchase;
h. Purchases made with discounts (type of deal and types of products);
i. Socio-demographic location code;
j. Household income;
k. US Geography (West/Southwest, Pacific, Northwest, Northeast, Central, South, Upper New England, Florida)
l. Time as customer; and/or
m. Previous promotion response (type of promotion and all associated terms) behavior variables (time, day, other product purchased outside promotion in transaction).

In a related embodiment, the shopping promotion algorithm 900 can evaluate the base variables and derive additional base variables using various well-known methods, including time series ratio analysis, cross-variable analysis, time event ratio analysis, event recurrence analysis, event normalization, and time since event analysis.

In a related embodiment, a base variable can be derived from historical transaction data, by:
a. Selection, wherein some historical data variables are selected to be base variables;
b. Calculation, wherein calculated base variables are derived from historical transaction data, including statistical measures, such as for example averages, maximum, and minimum value.

In a related embodiment, the shopping promotion algorithm 900 can use statistical regression analysis to predict the likelihood that a customer will respond to a particular promotion, which can both serve to raise average revenue per customer sales transaction and the number of sales transactions, by selecting optimal promotions for presentation to users 120.

In a related embodiment, the shopping promotion algorithm 900 can score, i.e. provide calculated odds of response, for each customer, such that all customers are ordered based on their likelihood to respond to a particular promotion.

In a related embodiment, a promotion can be defined as a combination of one or more product(s) with associated terms and conditions.

In a related embodiment, the shopping promotion algorithm 900 will get continuously more accurate in predicting customer behavior, as it captures more and more data on each consumer's purchasing patterns.

In a further related embodiment, as accuracy of the shopping promotion algorithm 900 increases, more relevant and effective promotions can be sent to the customer 120 in order to encourage additional buying behavior, such as additional transactions and/or higher priced transactions.

In a related embodiment, the shopping promotion algorithm 900 can examine purchasing patterns of similar customers in order to identify which products are relevant now and which product types are potentially relevant. For example:
a. A customer (based on customer profile) that purchases healthy foods for lunch, may be more likely to accept a promotion for a healthy mid-day snack, thereby generating an additional transaction; and
b. A customer (based on customer profile) that purchases only with discounts for individual items may be more likely to accept a discounted combo meal, thereby generating a higher price transaction.

In a related embodiment, a customized customer promotion can be displayed on an application home page or application window in the self-checkout device 104 and/or can be emailed to the user 120.

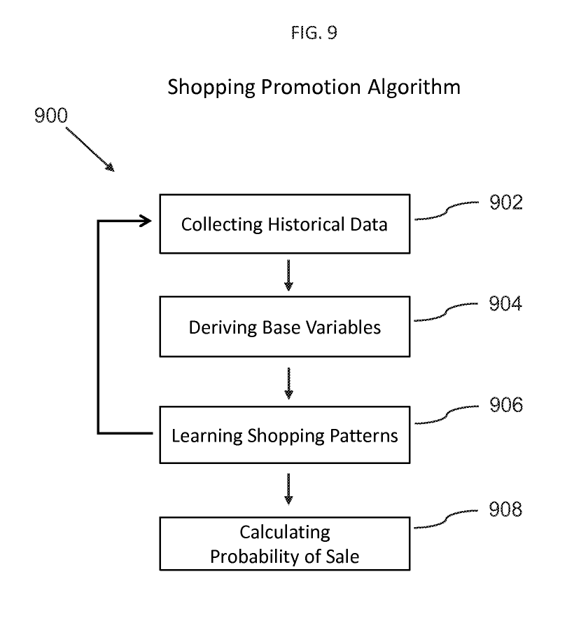

In a related embodiment, the shopping promotion algorithm 900, as shown in FIG. 9, can comprise:
a. Collecting historical data 902, wherein historical sales transaction data are stored, in order to capture a statistically sound dataset of sales transactions, which includes different promotion types, market, product types and customer types;
b. Deriving base variables 904, which includes aggregating historical base variable data, and deriving additional variables;
c. Learning shopping patterns 906, which includes learning correlations between base variables and completed sales transaction, including determining which subsets of base variables have the highest predictive power to indicate generation of a particular sales transaction;
d. Calculating probability of sale 908, wherein a probability of a sales transaction for a customer in relating to a predetermined promotion is calculated using the learned correlations.

In a related embodiment, the steps a.-c. can be repeated in a continuing process.

In a related embodiment, the sub-act of learning correlations in the act of learning shopping patterns 906 can be configured via well-known methods of machine learning, including deep learning, neural networks, genetic algorithms, support vector machines, and cluster classification.

In a related embodiment, the transaction manager 210 of the self-checkout server 102 can be configured to store and process historical transaction data and base variables in communication with the transaction database 212.

In a further related embodiment, the shopping analyzer 222 of the self-checkout server 102 can be configured to calculate correlations between base variables and completed sales transaction, by use of a machine learning processing.

In a yet further related embodiment, the machine learning processing can be configured according to well-known algorithms in deep learning, neural networks, genetic algorithms, support vector machines, cluster classification, statistical regression analysis, and other machine learning methods and algorithms.

In another yet further related embodiment, the shopping analyzer 222 can be configured to calculate a probability of sale of a predetermined promotion in relation to a specific customer, based on processing of the calculated correlations.

In various related embodiments, the system for self-checkout shopping 100 can be employed in a physical store, wherein the physical store is:
a. A store with only staffed checkout stations, wherein the store does not have self-service checkout stations, such that the system for self-checkout shopping 100 can enable a conventional store to make a low-cost upgrade to optional customer self-service;
b. A store with only self-service checkout stations, wherein the store does not have staffed checkout stations;
c. A store with both staffed checkout stations and self-service checkout stations; or
d. A store that does not have any checkout stations, but relies solely on the system for self-checkout shopping 100 to manage purchasing transactions in the store, which for example can be a usage-scenario for a dedicated micro-store inside a company.

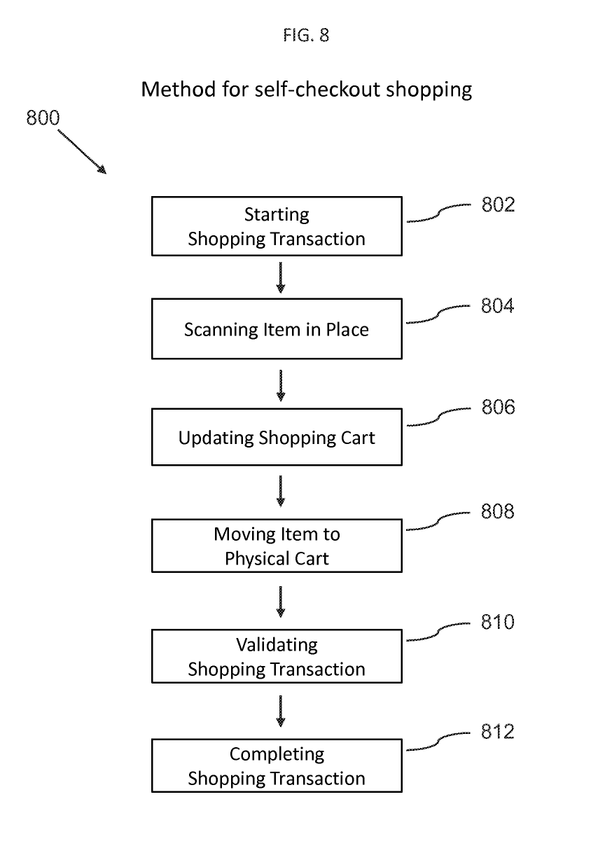

In an embodiment, as illustrated in FIG. 8, a method for self-checkout shopping 800, can include:
a. Starting shopping transaction 802, wherein a user enters a physical shopping store while carrying self-checkout device 104, which can be a mobile computing device, such as a smartphone;
b. Scanning item in place 804, wherein the user scans an item in the store with the mobile computing device;
c. Updating shopping cart 806, wherein a shopping cart maintained on the mobile computing device is updated with the item that was scanned by the user;
d. Moving item to physical cart 808, wherein the user moves the scanned item to a physical cart that is carried by the user;
e. Repeating steps b.-d. until the user has no more items to scan;
f. Validating shopping transaction 810;
g. Completing shopping transaction 812, wherein the user reviews the shopping cart on a screen of the mobile device, and pays for the items.

In related embodiments, steps b)-d) can be done in a different sequence or done simultaneously.

In a related embodiment, the act of scanning an item in place 804 can further include capturing a video or picture showing the item being removed from the shelf.

In a related embodiment, the act of completing shopping transaction 812 can further include taking a video or picture showing all the items in the physical cart.

In a further related embodiment, the act of completing shopping transaction 812 can further include storing a recording, including a video capture or a sequence of image captures, of the physical store from the time period of the shopping transaction, such that the images or video is captured by at least one shop camera 208 of the self-checkout server 102.

In a further related embodiment, the act of completing shopping transaction 812 can further include printing a receipt on a printer. The printer can for example be an NFC enabled printer, such that the shopping controller 310 prints a receipt via NFC communication via the input/output 306 with the printer.

In a related embodiment, validating shopping transaction 810 can further include:
The user placing the shopping cart on a shop weighing system 116 to obtain a physical weight of items in the physical cart, wherein the self-checkout device 104 determines a calculated weight of items in the shopping cart, such that the shopping transaction is validated by determining that the physical weight and the calculated weight are substantially equal.

In a related embodiment, validating shopping transaction 810 can further include:
The user taking a picture with the self-checkout device 104, such that the picture contains all items in the physical cart.

In a related embodiment, the method for self-checkout shopping 800 can further include capturing a video recording of the physical shopping store from a time period of the shopping transaction, such that the act of completing the shopping transaction, further comprises storing the recording on a self-checkout server.

In a related embodiment, the act of starting shopping transaction 802 can further include:
Selecting a sub-market, wherein the user selects a sub-market for the shopping transaction.

In a further related embodiment, the act of starting shopping transaction 802 can further include:
The self-service device selecting the sub-market by processing a location service to determine a calculated location of the self-checkout device 104, and correlating the calculated location with a predetermined location of the sub-market.

In a related embodiment, the method for self-checkout shopping 800 can further include:
a. Calculating correlations between base variables and completed sales transactions, by executing a machine learning process;
b. Calculating a probability of sale of predetermined promotions, in relation to a customer, based on processing of the calculated correlations; and
c. Presenting promotions, wherein the promotions with a high probability of sale are presented to the user on the self-checkout device, during the shopping transaction.

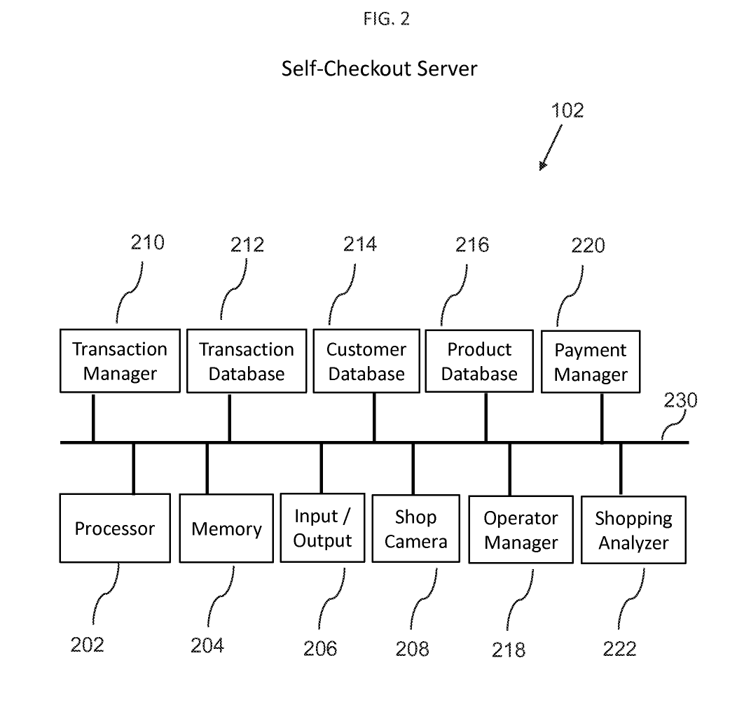

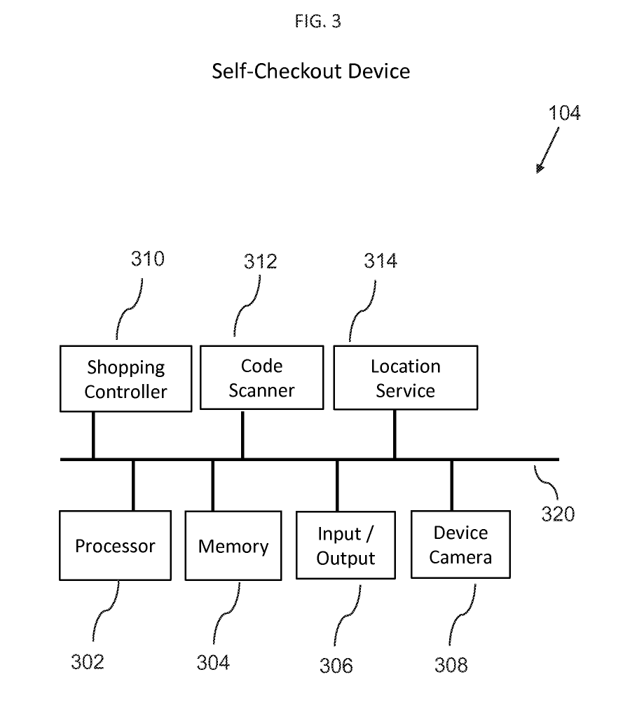

FIGS. 1, 2, 3, 8 and 9 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the system for self-checkout shopping 100, including the self-checkout server 102, and the self-checkout application 104. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as Amazon EC2 or Microsoft Azure.

It shall be understood that the above-mentioned components of the self-checkout server 102 and the self-checkout device 104 are to be interpreted in the most general manner.

For example, the processors 202 302, can each respectively include a single physical microprocessor or microcontroller, a cluster of processors, a datacenter or a cluster of datacenters, a computing cloud service, and the like.

In a further example, the non-transitory memory 204 and the non-transitory memory 304 can each respectively include various forms of non-transitory storage media, including random access memory and other forms of dynamic storage, and hard disks, hard disk clusters, cloud storage services, and other forms of long-term storage. Similarly, the input/output 206 and the input/output 306 can each respectively include a plurality of well-known input/output devices, such as screens, keyboards, pointing devices, motion trackers, communication ports, and so forth.

Furthermore, it shall be understood that the self-checkout server 102 and the self-checkout device 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the self-checkout device 104 communicates with the self-checkout server 102 over a network 106, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the self-checkout server 102 and the self-checkout device 104. The components of the self-checkout server 102 can be distributed over a plurality of physical, logical, or virtual servers. Parts or all of the components of the self-checkout device 104 can be configured to operate in the self-checkout server 102, whereby the self-checkout device 104 for example can function as a thin client, performing only graphical user interface presentation and input/output functions. Alternatively, parts or all of the components of the self-checkout server 102 can be configured to operate in the self-checkout device 104.

In a further example alternative embodiment, the self-checkout system 100 can be employed by a plurality of store operators, each operating a plurality of individual stores, such that parts or all of the functionality of the self-checkout server 102 is configured to operate as a cloud service, providing component services of the self-checkout server 102 to physical self-checkout servers 102, which are located in shops or server facilities of individual store operators.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for self-checkout shopping, comprising:
a) a self-checkout server; and
b) a self-checkout device;
wherein the self-checkout device is configured to register items for purchase and process sales transactions in a store, such that the sales transactions are stored in the self-checkout server.

2. The system for self-checkout shopping of claim 1, wherein the self-checkout server further comprises:
a) a processor;
b) a non-transitory memory;
c) an input/output component; and
d) a transaction manager; and
e) a transaction database; all connected via
f) a data bus;
wherein the transaction manager is configured to store and process the sales transactions in communication with the self-checkout device.

3. The system for self-checkout shopping of claim 1, wherein the self-checkout server further comprises:
a payment manager;
wherein the payment manager is configured to process payments for the sales transactions.

4. The system for self-checkout shopping of claim 3, further comprising:
an external payment system;
wherein the payment manager communicates with the external payment, such that the external payment system processes the payments.

5. The system for self-checkout shopping of claim 3, further comprising:
a payroll system;
wherein the payment manager communicates with the payroll system, such that the payroll systems is configured to process the payments, by deducting purchase amounts from users employee payroll accounts.

6. The system for self-checkout shopping of claim 1, wherein the self-checkout device further comprises:
a) a processor;
b) a non-transitory memory;
c) an input/output component; and
d) a shopping controller;
wherein the shopping controller is configured to register items for purchase, and wherein the shopping controller communicates with the transaction manager of the self-checkout server, to store and process the sales transactions.

7. The system for self-checkout shopping of claim 6, wherein the self-checkout device further comprises:
a) a device camera; and
b) a code scanner;
wherein the code scanner is configured to capture a picture of an item code, in communication with the device camera, such that the code scanner is configured to decode the image to obtain an item number.

8. The system for self-checkout shopping of claim 6, wherein the self-checkout device further comprises:
a location service;
wherein the location service is configured to determine a location of the self-checkout device.

9. The system for self-checkout shopping of claim 1, further comprising:
a shop weighing system, which is connected to the self-checkout device via a network;
such that the shopping controller is configured to validate a weight of items in the shopping transactions.

10. The system for self-checkout shopping of claim 1, further comprising:
at least one shop camera, which is connected to the self-checkout device via a network;
such that the shopping controller is configured to capture and store a recording of a physical store, during a time period of the shopping transaction.

11. The system for self-checkout shopping of claim 6, wherein the recording is a video recording.

12. The system for self-checkout shopping of claim 6, wherein the self-checkout server further comprises:
an operator manager;
wherein the operator manager is configured to allow an operator to set-up a market with sub-markets, such that the shopping controller is further configured to allow a customer to select a sub-market for a shopping transaction.

13. The system for self-checkout shopping of claim 6, wherein the self-checkout server further comprises:
a shopping analyzer;
wherein the operator manager is configured to calculate correlations between base variables and completed sales transactions, by execution of a machine learning processing;
wherein the shopping analyzer is configured to calculate a probability of sale of a predetermined promotion, in relation to a customer, based on processing of the calculated correlations.

14. A method for self-checkout shopping, comprises:
a) starting a shopping transaction, wherein a user enters a physical shopping store while carrying a self-checkout device, wherein the self-checkout device is a mobile computing device;
b) scanning an item in place, wherein the user scans the item in the store with the self-checkout device;
c) updating shopping cart, wherein a shopping cart maintained on the self-checkout device is updated with the item that was scanned by the user;
d) moving item to physical cart, wherein the user moves the scanned item to a physical cart that is carried by the user;
e) repeating steps b) to d) until the user has no more items to scan;
g) completing shopping transaction, wherein the user reviews the shopping cart on a screen of the mobile device, and pays for the items.

15. The method for self-checkout shopping of claim 14, further comprising:
f) validating shopping transaction, which is performed immediately before the act of completing shopping transaction, wherein the user places the shopping cart on a shop weighing system to obtain a physical weight of items in the physical cart, and wherein the self-checkout device determines a calculated weight of items in the shopping cart, such that the shopping transaction is validated by determining that the physical weight and the calculated weight are substantially equal.

16. The method for self-checkout shopping of claim 14, further comprising:
g) validating shopping transaction, which is performed immediately before the act of completing shopping transaction, wherein the user takes a picture with the self-checkout device, such that the picture contains all items in the physical cart.

17. The method for self-checkout shopping of claim 14, further comprising capturing a video recording of the physical shopping store from a time period of the shopping transaction, such that the act of completing the shopping transaction, further comprises storing the recording on a self-checkout server.

18. The method for self-checkout shopping of claim 14, wherein the act of starting the shopping transaction, further comprises selecting a sub-market, wherein the user selects a sub-market for the shopping transaction.

19. The method for self-checkout shopping of claim 18, wherein the self-service device selects the sub-market by processing a location service to determine a calculated location of the self-checkout device, and correlating the calculated location with a predetermined location of the sub-market.

20. The method for self-checkout shopping of claim 14, further comprising:
a) calculating correlations between base variables and completed sales transactions, by executing a machine learning process;
b) calculating a probability of sale of predetermined promotions, in relation to a customer, based on processing of the calculated correlations; and
c) presenting promotions, wherein the promotions with a high probability of sale are presented to the user on the self-checkout device, during the shopping transaction.
